(19) United States
(12) Patent Application Publication
(10) Pub. No.: US 2026/0322490 A1
(43) Pub. Date: Oct. 15, 2026

(54) System and Method for Active Pointing, Acquisition, and Tracking in Free Space Optical Communication Terminals

(71) Applicant: KlatchWERX LLC, Dover, DE (US)

(72) Inventors: Alexander J. Hallock, Littleton, MA (US); Michael Vestel, San Francisco, CA (US)

(21) Appl. No.: 19/550,233

(22) Filed: Feb. 25, 2026

Related U.S. Application Data
(60) Provisional application No. 63/787,112, filed on Apr. 11, 2025.

(51) Int. Cl. H04B 10/11; H04B 10/03

(52) U.S. Cl. CPC H04B 10/11; H04B 10/03

(57) ABSTRACT

A system and method for establishing and maintaining free space optical communication links through active pointing, acquisition, and tracking between optical terminals. The system encodes data onto modulated light, directs it through free space using beam steering elements, and converts it back into electrical signals at a receiver. Terminals autonomously locate partner terminals, establish precise alignment, and continuously correct for environmental disturbances including vibration, thermal drift, and atmospheric turbulence through closed-loop feedback. The beam steering elements may comprise optical phased arrays, liquid crystal spatial light modulators, MEMS mirrors, metasurfaces, or other solid-state or miniaturized steering mechanisms. Self-healing operation detects link disruptions, classifies them, and autonomously re-establishes connections through directed search and re-acquisition. A network-level orchestration method enables a centralized controller to manage link topologies across a plurality of terminals, supporting dynamic reconfiguration, redundancy, and scalability within deployment environments such as data centers.

### CROSS-REFERENCE TO RELATED APPLICATIONS

Priority is claimed in the application data sheet to the following patents or patent applications, each of which is expressly incorporated herein by reference in its entirety:
63/787,112

### BACKGROUND OF THE INVENTION

### Field of the Invention

The present invention relates to the field of free space optical communications, particularly to systems and methods for pointing, acquisition, and tracking between optical terminals to establish and maintain reliable wireless optical data links.

### Discussion of the State of the Art

The current state of the art in communications revolves around radio frequency (RF) systems, which have traditionally dominated the field of wireless communication. While RF systems can effectively transmit data over considerable distances, they are inherently limited by bandwidth constraints and are susceptible to interference and detection, particularly in contested environments.

A variety of Free Space Optical (FSO) systems have been built and tested. The general approach of encoding electronic data into light, sending the light across some distance, and then decoding it back into electronic data is established. There are some well-known difficulties with this approach. Systems that function outdoors need to adapt to varying weather conditions, turbulence, and background light. Building sway, vibration, or temporarily occluding the beam breaks the link that then needs to be quickly and effectively reestablished. While there are some examples of actively aligned systems, they are far too large, complex, and/or expensive to be effectively mass produced. For this type of system to become a common part of the world telecommunications network, there are still technical challenges that need to be addressed.

Pointing, Acquisition, and Tracking (PAT) is fundamental to establishing and maintaining a reliable FSO communication link between two optical terminals. Because laser beams are narrow, precise alignment between the transmitter and receiver is crucial. PAT systems point to get the beam in the right general direction, acquire by finding the precise location of the partner and locking onto its signal, then track by continuously maintaining the alignment for stable communication.

Pointing is broadly broken down into mechanical and nonmechanical or solid-state means. Mechanical pointing is done by gimbals which are multi-axis rotational mounts. They can hold optical elements like mirrors or lenses. Fast Steering Mirrors (FSMs) are mirrors that can be actuated quickly and precisely with piezoelectric motors. Deformable mirrors can be flexed in a variety of ways to affect the wavefront of the beam. Micro-Electro-Mechanical Systems (MEMS) are ways to make and actuate mirrors or arrays of mirrors. Nonmechanical techniques include Optical Phased Arrays (OPAs) where an array of emitters can control the phase and intensity independently to create a programmable interference pattern. Spatial Light Modulators (SLMs) control the phase and/or amplitude of light on a pixel-by-pixel basis.

Acquisition and tracking are generally accomplished by three methods. Beacon tracking involves using a bright and distinct light source, which is not the communications channel, for terminals to locate and identify each other. Image tracking is done by using a camera along with image analysis software to identify and center another terminal in a complex scene. Power optimization is done by dithering the beam steering mechanism while monitoring received power and keeping the system at a maximum. A complete system may be a hybrid containing multiple elements. Predictive tracking where the system uses algorithms that predict the future movement of the terminals, or the effects of atmospheric turbulence can improve tracking accuracy and reduce latency in the alignment process. This might involve machine learning and artificial intelligence routines.

The complexity and specific techniques used for PAT depend heavily on the application, the distance between the terminals, the expected environmental conditions, and the required data rates. For instance, a short-range, fixed terrestrial link might need a simpler PAT system than a long-range inter-satellite link involving high-speed relative motion. Currently, improving range or reliability necessitates the use of larger and heavier equipment to achieve bigger apertures for transmitting and receiving light. This equipment includes gimbals, lenses, lasers and detectors. In contrast, non-mechanical technologies scale with surface area rather than volume. These non-mechanical options are generally smaller, lighter, and more easily manufactured on a larger scale, all while incurring minimal additional costs for the larger aperture size achieved.

### SUMMARY OF THE INVENTION

The inventor has developed a system and method for active pointing, acquisition, and tracking in free space optical communication terminals. The present invention describes free space optical communication systems that employ active pointing, acquisition, and tracking to establish and maintain reliable wireless optical data links between terminals. The disclosed systems encode data onto modulated light, direct it through free space using beam steering elements, and convert it back into electrical signals at a receiver. Active beam steering enables the terminals to autonomously locate one another, establish alignment, and continuously compensate for environmental disturbances such as vibration, thermal drift, and atmospheric turbulence without manual intervention.

The invention includes multiple system architectures employing different beam steering technologies including optical phased arrays, liquid crystal spatial light modulators, MEMS mirrors, metasurfaces, and other solid-state or miniaturized steering mechanisms. Certain embodiments separate the alignment and data transmission functions onto independent beacon and signal channels, while others leverage commercially available transceivers to simplify integration with existing network infrastructure. The methods cover the full operational lifecycle of an optical link, from initial autonomous acquisition through active tracking and maintenance to self-healing recovery following disruptions. A network-level orchestration method enables a centralized controller to manage link topologies across a plurality of terminals, supporting dynamic reconfiguration, redundancy, and scalability within deployment environments such as data centers.

The disclosed systems offer several performance advantages over conventional wired and radio frequency communication alternatives. Because the optical signal propagates through free space along a direct line-of-sight path, the communication link follows the shortest geometric distance between terminals, avoiding the routing constraints and excess cable length inherent in wired installations. Light travels faster through air than through glass fiber, providing a measurable latency reduction that is advantageous in environments where minimizing signal delay is a priority. The bandwidth of a free space optical link is not subject to the spectral allocation constraints that limit radio frequency systems, nor is it constrained by the physical characteristics of a cable medium, enabling the system to support high data throughput without requiring additional physical infrastructure as capacity demands increase. The optical carrier is inherently immune to electromagnetic interference, allowing the system to operate reliably in environments with dense electronic equipment, high-power electrical systems, or other sources of radio frequency noise that would degrade conventional wireless links. The system is protocol agnostic, capable of transmitting any standard data format without requiring protocol-specific hardware or conversion at the optical layer. In an exemplary embodiment, the system may operate at infrared wavelengths selected to comply with applicable eye safety standards, enabling deployment in occupied spaces without requiring restricted access zones or additional safety enclosures. The active pointing, acquisition, and tracking capability ensures high uptime and utilization efficiency by continuously maintaining optimal alignment, autonomously recovering from disruptions, and preventing the gradual signal degradation that can occur in static systems subject to environmental drift over time.

According to a preferred embodiment, an optical communication system comprising: a first terminal comprising a light source configured to generate a modulated optical signal encoding a data stream, a beam steering element configured to direct the modulated optical signal through free space toward a second terminal, and a controller configured to command the beam steering element; a second terminal comprising collection optics configured to receive the modulated optical signal from the first terminal, a detector configured to convert the received modulated optical signal into an electrical data stream, and a spatially sensitive detector configured to generate alignment information indicative of an angular offset between the modulated optical signal and the second terminal; a pointing, acquisition, and tracking system configured to perform an acquisition sequence in which the beam steering element scans an angular search region to locate the second terminal and iteratively refines alignment based on the alignment information generated by the spatially sensitive detector until a signal quality metric exceeds a predetermined acquisition threshold; and a feedback system configured to continuously monitor the signal quality metric during an established communication link and to compute and apply steering corrections to the beam steering element to maintain alignment between the first terminal and the second terminal in the presence of environmental disturbances; wherein the beam steering element comprises at least one of a microelectromechanical systems mirror, an optical phased array, a liquid crystal spatial light modulator, a metasurface, a digital micromirror device, an acousto-optic modulator, an electro-optic modulator, a Risley prism, or a liquid lens, is disclosed.

According to another preferred embodiment, a method for establishing and maintaining a free space optical communication link between a first terminal and a second terminal, the method comprising the steps of: activating a beacon signal on a first terminal, wherein the beacon signal emits light across an angular search region; scanning the angular search region using a beam steering element on the first terminal to sweep the beacon signal across candidate locations of a second terminal; detecting a beacon signal from the second terminal using a spatially sensitive detector on the first terminal, wherein detection of the beacon signal indicates an angular direction of the second terminal; computing a coarse alignment vector based on the detected beacon signal and directing the beam steering element toward an estimated location of the second terminal; refining alignment by iteratively adjusting the beam steering element based on feedback from the spatially sensitive detector until a signal quality metric exceeds a predetermined acquisition threshold; establishing a modulated data link between the first terminal and the second terminal by transmitting encoded optical data along a refined alignment vector; monitoring the signal quality metric during the established modulated data link and computing a steering correction vector when the signal quality metric falls below a predetermined maintenance threshold; and applying the steering correction vector to the beam steering element to adjust a direction of the modulated data link toward the second terminal to maintain alignment in the presence of, is disclosed.

According to an aspect of an embodiment, the first terminal further comprises a beacon light source configured to emit a beacon signal at a wavelength distinct from the modulated optical signal, and the second terminal further comprises a beacon filter configured to pass light at the beacon wavelength while rejecting light at the wavelength of the modulated optical signal, wherein the pointing, acquisition, and tracking system performs the acquisition sequence based on the beacon signal independently of the modulated optical signal.

According to an aspect of an embodiment, the first terminal further comprises a Small Form-factor Pluggable transceiver device configured to generate the modulated optical signal and output the modulated optical signal through a fiber optic port, and a collimator configured to receive the modulated optical signal from the fiber optic port and produce a collimated beam directed onto the beam steering element.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for a free space optical communication link between a transmitter and a receiver.

FIG. 2 is a block diagram illustrating an exemplary system architecture for a free space optical communication link between a transmitter and a receiver.

FIG. 3 is a block diagram illustrating an exemplary system architecture for a free space optical communication link employing an optical phased array for nonmechanical beam steering.

FIG. 4 is a block diagram illustrating an exemplary system architecture for a free space optical communication link employing a beacon-based acquisition system and a liquid crystal spatial light modulator for nonmechanical beam steering.

FIG. 5 is a block diagram illustrating an exemplary system architecture for a free space optical communication link.

FIG. 6 is a flow diagram illustrating an exemplary method for autonomous acquisition of a free space optical communication link between two terminals.

FIG. 7 is a flow diagram illustrating an exemplary method for active tracking and maintenance of an established free space optical communication link between two terminals.

FIG. 8 is a flow diagram illustrating an exemplary method for self-healing and reconfiguration of a free space optical communication link following a disruption event.

FIG. 9 is a flow diagram illustrating an exemplary method for network-level orchestration and topology management of a plurality of free space optical terminals within a deployment environment.

FIG. 10 illustrates an exemplary computing environment on which an embodiment described herein may be implemented.

### DETAILED DESCRIPTION OF THE INVENTION

The inventor has conceived, and reduced to practice, a system and method for active pointing, acquisition, and tracking in free space optical communication terminals. The present invention pertains to systems and methods for establishing, maintaining, and recovering free space optical communication links between terminals using active pointing, acquisition, and tracking. The systems transmit data by encoding it onto modulated light and directing it through free space to a receiver, where the light is converted back into an electrical data signal. Unlike conventional static optical links that rely on fixed alignment, the disclosed systems employ active beam steering elements to autonomously locate partner terminals, establish precise alignment, and continuously correct for environmental disturbances including thermal drift, vibration, atmospheric turbulence, and physical obstructions. The active tracking capability enables self-healing operation in which a disrupted link is automatically detected, classified, and re-established without manual intervention, as well as dynamic reconfiguration in which communication paths can be redirected between different terminal pairs in response to changing network requirements.

Several embodiments of the beam steering and link architecture are disclosed. In one embodiment, an optical phased array electronically steers a shaped beam by controlling the relative phase across a plurality of emitting elements to create a programmable interference pattern, enabling fully solid-state operation with no mechanical movement. In another embodiment, a beacon-based acquisition system operates alongside a liquid crystal spatial light modulator that steers the communication signal, separating the alignment and data transmission functions onto independent optical channels for optimized performance of each. In a further embodiment, commercially available Small Form-factor Pluggable transceiver devices are paired with reflective liquid crystal spatial light modulators and collimating optics to leverage existing networking components and standard data processing protocols. The beam steering element in any of these embodiments may alternatively comprise a MEMS mirror, a metasurface, a digital micromirror device, Risley prisms, liquid lenses, or any other suitable steering technology, as the disclosed system architectures are agnostic to the specific steering mechanism employed.

The disclosed methods address the full operational lifecycle of a free space optical link, including autonomous acquisition in which terminals locate and connect to one another without manual intervention, active tracking in which a closed-loop feedback system continuously monitors signal quality and applies corrective steering adjustments, and self-healing in which link disruptions are detected and autonomously recovered through directed search and re-acquisition. A network-level orchestration method is further disclosed in which a centralized controller manages a plurality of terminals within a deployment environment, computing link topologies, issuing assignment and reconfiguration instructions, and monitoring aggregate network health. The disclosed systems and methods are particularly suited to environments such as data centers where stability, turnkey installation, scalability, reconfigurability, and high uptime are critical operational requirements, and where the line-of-sight propagation path, protocol agnosticism, electromagnetic interference immunity, and latency advantages of free space optical communication offer performance benefits over conventional wired or radio frequency alternatives.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

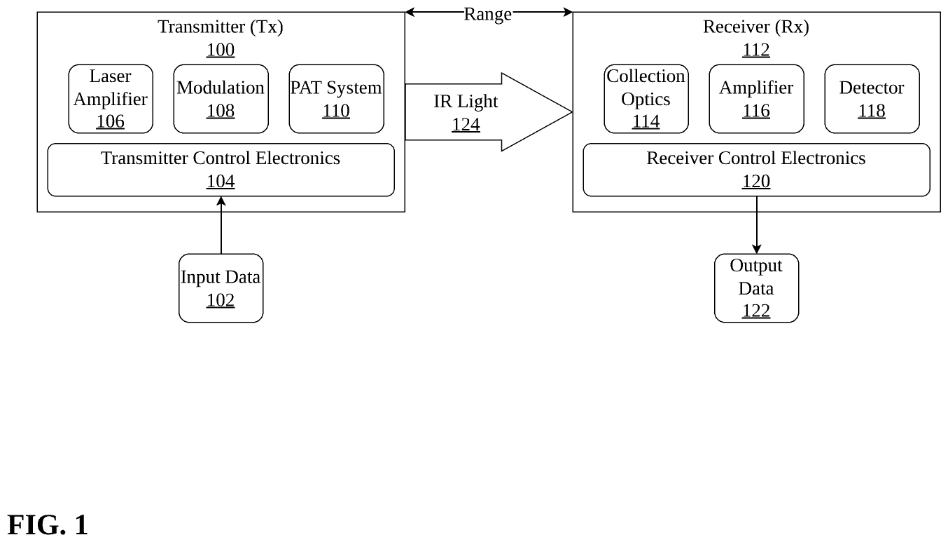

FIG. 1 is a block diagram illustrating an exemplary system architecture for a free space optical communication link between a transmitter and a receiver. The system transmits data by encoding it onto a modulated beam of light and directing that beam across a range to a receiver where the light is converted back into an electrical data signal.

A transmitter 100 receives input data 102 comprising an electronic data stream to be transmitted across the optical link. Input data 102 may originate from any standard network interface including, by way of example, an ethernet connection, a fiber channel interface, or any protocol-agnostic data source. Transmitter control electronics 104 process input data 102 and convert it into a format and encoding scheme suitable for optical transmission. In an exemplary embodiment, transmitter control electronics 104 may comprise an ethernet media converter or similar commercially available device that translates standard network traffic into a signal compatible with the downstream optical components.

A laser 106 generates a coherent light source that serves as the optical carrier for the encoded data. Laser 106 may operate at any suitable wavelength, and in an exemplary embodiment operates in the infrared spectrum to take advantage of favorable atmospheric transmission characteristics and eye safety considerations. Where additional optical power is required to achieve a desired link range, an amplifier may be incorporated at or after laser 106 to increase the output power of the optical signal. Modulation 108 encodes the data onto the optical carrier produced by laser 106 by varying one or more properties of the light, such as intensity, phase, or polarization, in accordance with the data stream. On-off keying is one exemplary modulation scheme in which binary data is represented by the presence or absence of optical power, though other widely adopted encoding standards may be employed depending on the data rate and link budget requirements.

A Pointing, Acquisition, Tracking system (PAT system) 110 directs the modulated optical beam toward a receiver 112 located at the opposite end of the link. PAT system 110 is responsible for pointing the beam in the correct general direction, acquiring the precise location of receiver 112, and continuously tracking receiver 112 to maintain alignment as conditions change. PAT system 110 may employ any of a variety of beam steering technologies including, by way of example, MEMS mirrors, optical phased arrays, liquid crystal spatial light modulators, metasurfaces, digital micromirror devices, Risley prisms, or liquid lenses. The modulated and steered light exits transmitter 100 as IR light 124 and propagates through free space across the range separating the two terminals. IR light 124 represents the optical signal as it traverses the open-air path between transmitter 100 and receiver 112, and is subject to atmospheric effects including turbulence, scintillation, and absorption that the system is designed to accommodate through active tracking and sufficient link margin.

At the opposite end of the link, collection optics 114 on receiver 112 gather incoming IR light 124 and focus it onto downstream detection components. Collection optics 114 may comprise a lens, a telescope, or any suitable optical assembly dimensioned to provide an effective receive aperture for the expected range and beam divergence. An amplifier 116 increases the power of the collected optical signal where the received signal strength is insufficient for reliable detection. A detector 118 converts the amplified optical signal back into an electrical signal that represents the originally transmitted data. Detector 118 may be, by way of example, a photodiode, an avalanche photodiode, or a quantum well infrared photodetector, selected based on the operating wavelength and sensitivity requirements of the link. Receiver control electronics 120 interpret the electrical signal produced by detector 118, decode the transmitted data, and provide output data 122 in a format compatible with the receiving network infrastructure.

Pointing is broadly broken down into mechanical and nonmechanical or solid-state means. Mechanical pointing is done by gimbals which are multi-axis rotational mounts. They can hold optical elements like mirrors or lenses. Fast Steering Mirrors (FSMs) are mirrors that can be actuated quickly and precisely with piezoelectric motors. Deformable mirrors can be flexed in a variety of ways to affect the wavefront of the beam. Micro-Electro-Mechanical Systems (MEMS) are ways to make and actuate mirrors or arrays of mirrors. Nonmechanical techniques include Optical Phased Arrays (OPAs) where an array of emitters can control the phase and intensity independently to create a programmable interference pattern. Spatial Light Modulators (SLMs) control the phase and/or amplitude of light on a pixel-by-pixel basis. Acousto-Optic Modulators (AOMs) steer beams by using acoustic waves propagating through a crystal or other medium to create a diffraction grating that deflects light at an angle proportional to the acoustic frequency, enabling rapid beam deflection without mechanical movement. Electro-Optic Modulators (EOMs) achieve beam steering by applying an electric field across a crystal exhibiting the Pockels effect or Kerr effect to alter the refractive index of the material, causing angular deflection of light passing through it. Metasurfaces comprising nanostructured elements with subwavelength features can impose spatially varying phase profiles on transmitted or reflected light, enabling planar beam steering with no moving parts and a highly compact form factor.

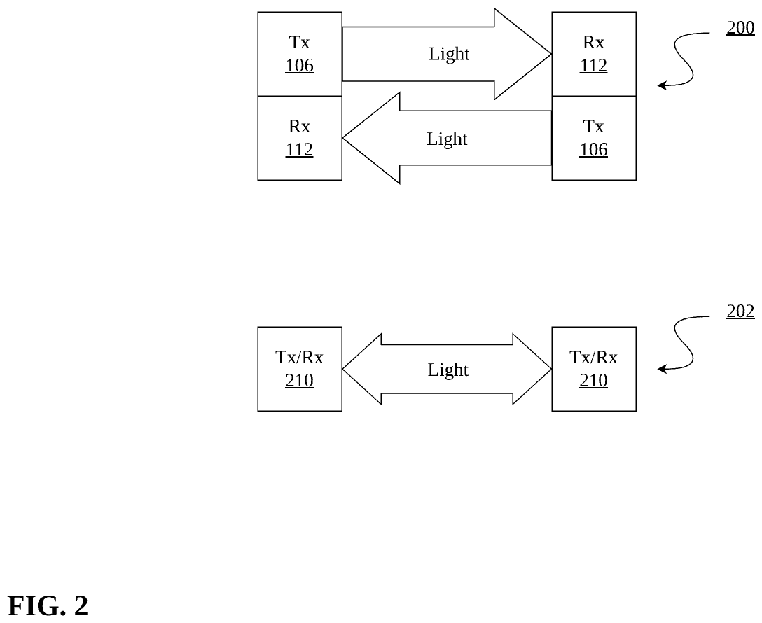

FIG. 2 is a block diagram illustrating an exemplary system architecture for a free space optical communication link between a transmitter and a receiver. A first configuration 200 employs separate transmitter and receiver at each end of the link. On one side, a transmitter 106 generates and directs a modulated optical beam toward the opposite terminal, while a receiver 112 at the same location independently collects and detects incoming light from the partner terminal. The partner terminal mirrors this arrangement with its own transmitter 106 and receiver 112 operating in the opposite direction. In first configuration 200, each transmitter 106 and receiver 112 maintains its own dedicated optical path, beam steering elements, and control electronics. This separation allows each subsystem to be independently optimized for its respective function. By way of example, transmitter 106 may use a beam steering element with high angular precision optimized for directing a narrow transmitted beam, while receiver 112 may use collection optics with a larger aperture optimized for gathering incoming light over a wider acceptance angle. First configuration 200 also permits each directional link to operate at the same wavelength since the transmit and receive paths are physically isolated from one another. However, this approach requires a greater total number of components, increases overall system size and weight, and demands that each PAT system independently acquire and track the partner terminal.

A second configuration 202 combines transmitter and receiver functionality into a unified transceiver at each end of the link. A transceiver 210 on one side communicates with a corresponding transceiver 210 at the opposite end over a shared optical path. In second configuration 202, common optics are employed to serve both the transmit and receive functions simultaneously, wherein a single output lens or aperture assembly also operates as the collection lens for incoming light. This dual use of optical elements significantly reduces the size, weight, and component count of each terminal, making second configuration 202 particularly advantageous for deployments where compactness and manufacturability are priorities, such as in data center environments where a large number of terminals may need to be installed in a confined space. Beam splitters, circulators, or wavelength-division elements within transceiver 210 separate the outgoing and incoming signals so that transmitted light does not interfere with received light despite sharing the same optical path. In an exemplary embodiment, each transceiver 210 may utilize slightly different wavelengths for the transmit and receive directions, allowing wavelength-selective filters to cleanly isolate the two signals while still sharing common optics. This wavelength pairing approach is well established in fiber optic networking, and commercially available bidirectional Small Form-factor Pluggable transceiver devices, by way of example, already implement this technique in a compact integrated package. Second configuration 202 also benefits from inherent alignment simplification, as the shared optical path ensures that the transmit and receive directions are coaligned through the same beam steering element, reducing the number of independent PAT corrections required to maintain a stable bidirectional link. In an exemplary embodiment, a single MEMS mirror, optical phased array, liquid crystal spatial light modulator, metasurface, or other beam steering element within transceiver 210 may steer both the outgoing beam and the effective receive field of view simultaneously, further reducing system complexity and enabling a more compact terminal design suitable for scalable manufacturing.

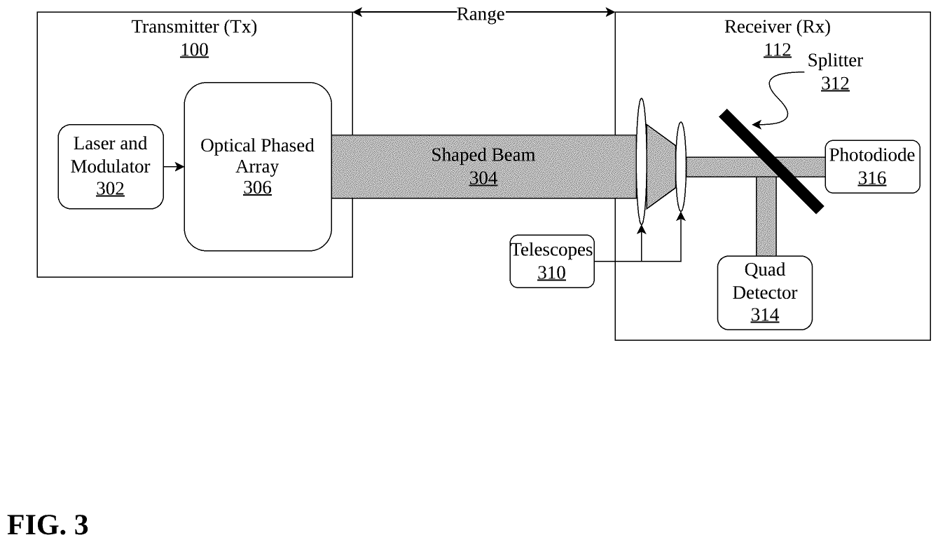

FIG. 3 is a block diagram illustrating an exemplary system architecture for a free space optical communication link employing an optical phased array for nonmechanical beam steering. This embodiment demonstrates a fully solid-state approach to pointing, acquisition, and tracking in which the transmitted beam is electronically steered without any physical movement of optical components.

A transmitter 100 comprises a laser and modulator 302 that generates a coherent optical carrier and encodes data onto it by varying one or more properties of the light in accordance with an input data stream. Laser and modulator 302 may be implemented as a single integrated device or as separate components coupled together via free space or optical fiber. In an exemplary embodiment, laser and modulator 302 may comprise a fiber-coupled laser source operating in the infrared spectrum paired with an external modulator capable of on-off keying or other encoding schemes suitable for the desired data rate. The modulated light output from laser and modulator 302 is directed into an optical phased array 306, which serves as the beam steering element for transmitter 100. Optical phased array 306 is a device that can electronically steer beams of light without any mechanical movement, functioning as the optical analog of a radio frequency phased array antenna. Optical phased array 306 operates by receiving the modulated light input and splitting it across a plurality of emitting elements, each of which has an independently controllable phase shifter. By precisely adjusting the relative phase of each emitting element, optical phased array 306 creates a programmable interference pattern that constructively combines in a desired output direction. Changing the phase distribution across the array changes the direction of the output beam, enabling rapid electronic steering across the field of regard without any moving parts. Optical phased array 306 may also shape the beam profile by controlling the amplitude and phase distribution across the array, allowing the system to adjust beam divergence and sidelobe characteristics to suit varying range and atmospheric conditions. The steered and shaped output from optical phased array 306 exits transmitter 100 as a shaped beam 304 that propagates through free space across the range to a receiver 112.

At receiver 112, one or more telescopes 310 collect incoming shaped beam 304 and concentrate the received light onto downstream optical and detection components. Telescopes 310 provide a large effective receive aperture that gathers sufficient optical power from shaped beam 304 after it has diverged and been attenuated over the propagation range. The collected light passes from telescopes 310 into a splitter 312, which divides the received optical signal between two separate detection paths. Splitter 312 directs a small percentage of the incoming light to a quad detector 314 and routes the remaining majority of the light to a photodiode 316. Quad detector 314 is a position-sensitive detector comprising four independent sensing quadrants, each of which measures the optical power incident upon it. By comparing the relative power levels across the four quadrants, quad detector 314 determines the spatial offset of the incoming beam relative to the center of the detector, providing a real-time measurement of angular misalignment between transmitter 100 and receiver 112 in two axes. This alignment information is fed back to the beam steering control system, which may reside at transmitter 100, at receiver 112, or at both terminals depending on the system configuration. In an exemplary embodiment, the alignment data from quad detector 314 may be communicated back to transmitter 100 over a low-bandwidth auxiliary channel, such as a radio frequency link, enabling optical phased array 306 to apply corrective phase adjustments that maintain precise aim at receiver 112. The auxiliary channel need not carry high data throughput, as a typical system checks and corrects alignment only a few times per second. Alternatively, in a bidirectional system where receiver 112 also has transmit capability, the alignment feedback may be sent optically over the reverse communication path. Photodiode 316 receives the majority of the collected light from splitter 312 and converts it back into an electrical signal representing the originally transmitted data. Photodiode 316 may comprise, by way of example, an InGaAs photodiode, an avalanche photodiode, or another detector technology selected based on the operating wavelength and sensitivity requirements of the link. The electrical output of photodiode 316 is then processed by receiver control electronics to decode the transmitted data and deliver it as an output data stream compatible with the receiving network infrastructure.

This embodiment achieves a complete free space optical communication link with no mechanical parts in the beam steering path. Because optical phased array 306 steers the beam electronically, the system can respond to alignment disturbances with switching speeds limited only by the phase shifter response time, which is typically on the order of microseconds to nanoseconds depending on the phased array technology employed. This rapid response enables the system to compensate for high-frequency vibration, atmospheric turbulence, and platform motion that would exceed the bandwidth of conventional mechanical steering approaches such as gimbals or motorized mirror mounts. Additionally, because optical phased array 306 scales with surface area rather than volume, larger effective apertures can be achieved without the corresponding increases in mass and mechanical complexity associated with scaling traditional lens and gimbal assemblies, making this approach particularly well suited for deployments requiring compact, lightweight terminals that can be manufactured at scale.

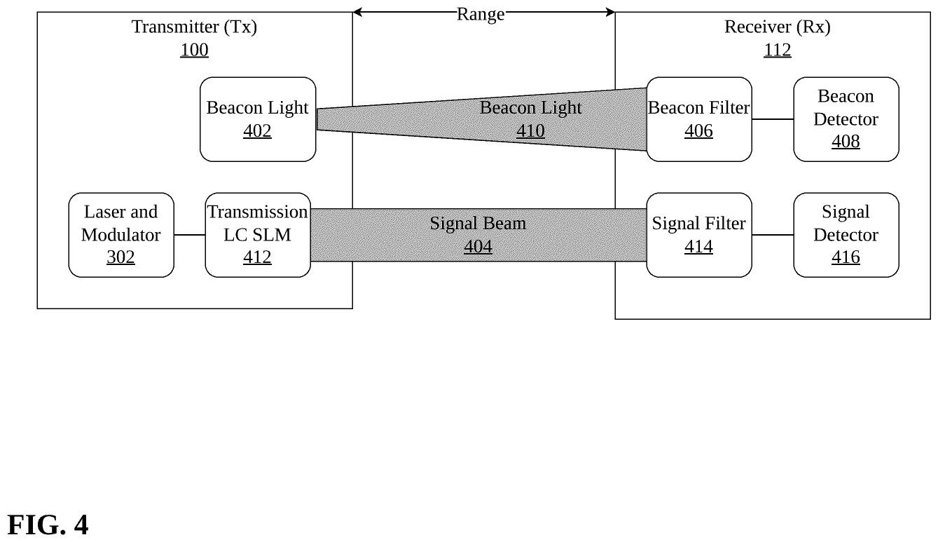

FIG. 4 is a block diagram illustrating an exemplary system architecture for a free space optical communication link employing a beacon-based acquisition system and a liquid crystal spatial light modulator for nonmechanical beam steering. This embodiment separates the alignment function from the data transmission function by using a dedicated beacon channel for pointing and acquisition while an independent signal channel carries the modulated communication data.

A transmitter 100 comprises two distinct optical subsystems operating in parallel. A beacon light 402 emits a broad or divergent beam of light that serves as a spatial reference for the receiver to locate transmitter 100 in space. Beacon light 402 may be, by way of example, a light-emitting diode or a laser operating at a wavelength distinct from the communication signal, selected to provide a wide angular coverage that increases the probability of detection during the initial acquisition phase. The beacon does not carry communication data and instead functions solely as a locating signal, allowing receiver 112 to determine the angular position of transmitter 100 relative to its own orientation. Because beacon light 402 is designed to cover a broad angular region, it can be detected by receiver 112 even before precise alignment has been established, enabling the system to bootstrap the acquisition process from an initially unknown or approximate pointing state. A laser and modulator 302 generates the communication signal by encoding input data onto a coherent optical carrier, as described with respect to previous embodiments. The modulated output from laser and modulator 302 passes through a transmission liquid crystal spatial light modulator 412, which steers the signal beam toward receiver 112. Transmission liquid crystal spatial light modulator 412 is a device that controls the amplitude, phase, and polarization of light as it passes through a layer of liquid crystal material arranged across an array of individually addressable pixels. By applying different electrical signals to each pixel, transmission liquid crystal spatial light modulator 412 spatially varies the optical properties of the liquid crystal layer to create a programmable phase profile that deflects the transmitted beam in a desired direction. This is another exemplary nonmechanical method for steering a beam, as the liquid crystal pixels are actuated entirely by electrical signals with no physical movement. The steered output exits transmitter 100 as a signal beam 404 that propagates across the range to receiver 112, while beacon light 410 from beacon light 402 simultaneously illuminates the region around receiver 112 to maintain a continuous spatial reference.

At receiver 112, the incoming light comprises two superimposed optical signals arriving from transmitter 100: beacon light 410 and signal beam 404, each operating at a different wavelength. A beacon filter 406 is a wavelength-selective optical element that passes only light at the beacon wavelength while rejecting light at the signal wavelength, isolating the beacon channel from the communication channel. The filtered beacon light is directed to a beacon detector 408, which measures the spatial characteristics of the incoming beacon to determine the angular position of transmitter 100 relative to receiver 112. Beacon detector 408 may be, by way of example, a camera capable of image analysis for alignment, or a spatially sensitive photodiode such as a position-sensitive detector or quad detector that can perceive the orientation of the incoming beacon light and compute an alignment offset in two axes. The alignment information produced by beacon detector 408 defines the relative positions of transmitter 100 and receiver 112 in space, and this information is used to command transmission liquid crystal spatial light modulator 412 on how to steer signal beam 404 for optimal link performance. In an exemplary embodiment, the alignment data may be communicated from receiver 112 back to transmitter 100 over a low-bandwidth radio frequency auxiliary link, or optically over a reverse communication path in a bidirectional configuration. Alternatively, in an exemplary embodiment where receiver 112 also employs a beam steering element, beacon detector 408 may directly command the local steering element to optimize the receive field of view toward the incoming signal.

A signal filter 414 performs the complementary function to beacon filter 406 by passing only light at the communication signal wavelength while rejecting light at the beacon wavelength, ensuring that beacon light 410 does not interfere with data reception. The filtered signal light is directed to a signal detector 416, which converts the modulated optical signal back into an electrical data stream. Signal detector 416 may be, by way of example, a photodiode or a quantum well infrared photodetector, selected based on the operating wavelength of signal beam 404 and the sensitivity and bandwidth requirements of the communication link. The electrical output of signal detector 416 is then processed by receiver control electronics to decode the transmitted data and deliver it to the receiving network infrastructure.

This embodiment offers several advantages arising from the separation of the beacon and signal channels. Because beacon light 402 can operate at a different power level, divergence angle, and modulation state than the communication signal, the acquisition system can be independently optimized for rapid partner detection without constraining the performance of the data link. By way of example, beacon light 402 may be configured with a wide divergence to flood a large angular region during initial search, while signal beam 404 maintains a narrow divergence for high power density and long-range data transmission. The beacon channel also provides a continuous, independent alignment reference that is unaffected by data encoding and modulation variations on the signal channel, enabling beacon detector 408 to produce stable tracking measurements even during periods of varying data traffic or link idle states. In an exemplary embodiment, the beam steering element at transmitter 100 may be replaced by a MEMS mirror, a metasurface, a digital micromirror device, or any other suitable steering technology while preserving the same dual-channel beacon and signal architecture, as the separation of alignment and communication functions is independent of the specific steering mechanism employed.

In an exemplary embodiment, beacon light 402 may be configured to serve a dual function as both a spatial reference for alignment and a low-bandwidth control communication channel between transmitter 100 and receiver 112. Rather than emitting a continuous, unmodulated signal whose sole purpose is to provide a detectable angular reference, beacon light 402 may be modulated by transmitter control electronics 104 to encode low-rate control data onto the beacon emission. The control data represents operational information intended for the partner terminal's control system and is distinct from the high-rate user data carried by signal beam 404 on the communication channel. By way of example, the control data may convey status messages such as whether transmitter 100 is powered on and operational, whether transmitter 100 is currently executing a beam steering adjustment and requires receiver 112 to hold its current alignment, whether transmitter 100 has detected a fault or degraded condition, or whether transmitter 100 is preparing to transition from acquisition mode to data transmission mode. The modulation applied to beacon light 402 for the purpose of encoding control data may be, by way of example, simple on-off keying, pulse position modulation, or amplitude modulation at a baud rate that is orders of magnitude lower than the data rate of signal beam 404. Because the control messages are short, infrequent, and limited in content, the modulation rate may be on the order of tens to hundreds of bits per second, which is readily achievable using the same LED or laser that serves as beacon light 402 without requiring additional drive circuitry or optical components. The low modulation rate also ensures that the spatial reference function of beacon light 402 is not materially impaired, as beacon detector 408 can still derive angular position information from the time-averaged intensity distribution of the beacon even while the beacon is being modulated with control data.

On the receive side, beacon detector 408 demodulates the low-rate control data from the incoming beacon signal in addition to measuring the spatial characteristics of the beacon for alignment purposes. Because beacon detector 408 is already configured to measure optical intensity, whether as a spatially sensitive photodiode detecting power levels across sensing regions or as a camera capturing frame-by-frame intensity, it is inherently capable of detecting the intensity variations introduced by the control data modulation. Receiver control electronics 120 extract the control data from the electrical signal produced by beacon detector 408 by applying appropriate filtering and demodulation routines to separate the low-rate control information from the spatial alignment measurements. In a bidirectional system where receiver 112 also incorporates a beacon light source, the control channel operates in both directions, enabling each terminal to communicate its status and coordination commands to its partner using only the beacon channels already present in the system. This eliminates the need for any external communication path between terminals, including radio frequency links, wired cables, or access to the end-user data network, all of which may be unavailable, impractical, or prohibited in the deployment environment. In a data center environment, by way of example, radio frequency transmissions may be restricted for security and electromagnetic interference reasons, and the installation of dedicated control wiring between terminals would undermine the advantages of a cable-free optical architecture. By embedding all inter-terminal coordination into the beacon channel, the system achieves fully autonomous operation in which every exchange of information between terminals, both the high-rate user data on the communication channel and the low-rate control data on the beacon channel, occurs exclusively over optical paths that are already part of the system architecture. This dual-function beacon approach supports the full range of coordination activities required for autonomous acquisition, active tracking, self-healing, and reconfiguration without introducing any additional hardware, communication infrastructure, or security exposure beyond what is already disclosed.

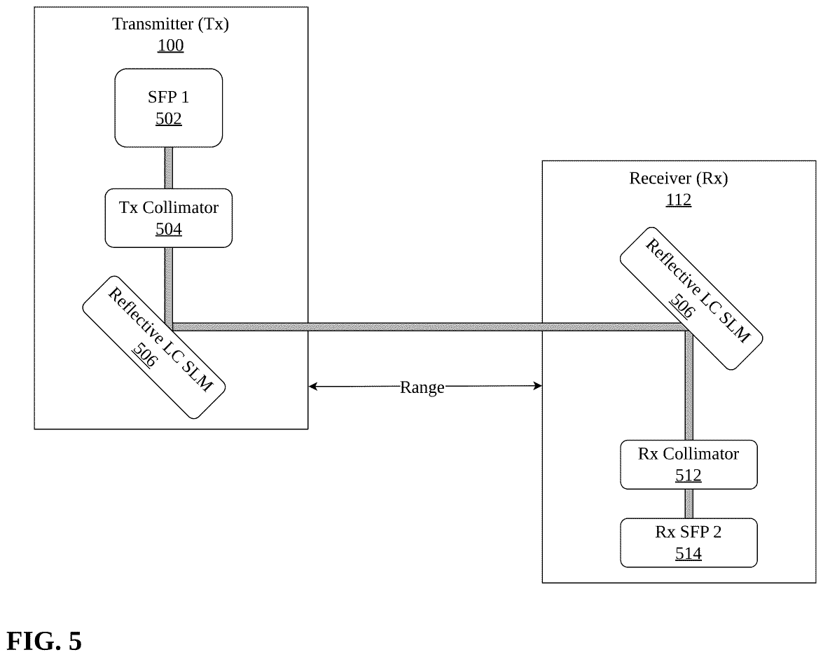

FIG. 5 is a block diagram illustrating an exemplary system architecture for a free space optical communication link. This embodiment leverages widely adopted networking components to minimize custom hardware requirements and simplify integration with existing network infrastructure.

A transmitter 100 comprises an SFP 1 502, which is a Small Form-factor Pluggable transceiver device of the type commonly used throughout the telecommunications and data networking industries. SFP 1 502 is a compact, hot-swappable transceiver that integrates a laser source, a modulator, amplification circuitry, detection circuitry, and control electronics into a single standardized package. These devices are manufactured in high volume to established industry form factors and data processing protocols, and are available in configurations supporting a wide range of data rates, wavelengths, and transmission distances. SFP 1 502 accepts input data from a host network device, encodes it onto a modulated optical signal, and outputs that signal through a fiber optic port using standard fiber connectors. By incorporating SFP 1 502 as the core data handling element, this embodiment takes advantage of the extensive development and miniaturization already achieved by the networking industry, eliminating the need to design custom laser, modulation, and detection subsystems from scratch. SFP 1 502 may be, by way of example, a bidirectional SFP that handles both transmit and receive functions within a single device using wavelength-division techniques to separate the two directions, or it may be a unidirectional SFP dedicated to transmission only, depending on the system configuration.

The fiber optic output from SFP 1 502 is coupled into a Tx collimator 504, which converts the diverging light exiting the fiber into a collimated beam suitable for free space propagation. Tx collimator 504 may comprise, by way of example, a fiber-coupled aspheric lens, a gradient-index lens assembly, or any other suitable collimating optic dimensioned to produce a beam diameter and divergence appropriate for the intended link range. The collimated beam from Tx collimator 504 is directed onto a reflective liquid crystal spatial light modulator 506, which steers the beam toward receiver 112. Reflective liquid crystal spatial light modulator 506 operates on the same principle as the transmission liquid crystal spatial light modulator described with respect to FIG. 4, controlling the phase and amplitude of light across an array of individually addressable liquid crystal pixels to create a programmable phase profile that deflects the beam in a desired direction. Reflective liquid crystal spatial light modulator 506 differs from a transmission type in that light is bounced off the surface of the device rather than passing through it, and both configurations are suitable for this application. The reflective configuration may offer advantages in certain implementations, as it allows the driving electronics to be placed behind the active liquid crystal layer without obstructing the optical path, potentially enabling higher fill factors and more compact integration. The steered beam exits transmitter 100 and propagates through free space across the range to receiver 112.

At receiver 112, the incoming light is intercepted by a second reflective liquid crystal spatial light modulator 506, which functions as the receive-side beam steering element. Reflective liquid crystal spatial light modulator 506 at receiver 112 captures the incoming beam and directs it into an Rx collimator 512, which focuses the received light back into an optical fiber. Rx collimator 512 performs the inverse function of Tx collimator 504, coupling free space light into a fiber core with sufficient alignment precision to deliver the signal to the downstream transceiver with minimal coupling loss. The fiber output of Rx collimator 512 connects to an Rx SFP 2 514, which is a second Small Form-factor Pluggable transceiver device that receives the optical signal through its fiber port, detects and demodulates the light, and outputs the recovered data to the receiving host network device. Rx SFP 2 514 may be wavelength-matched to SFP 1 502 to ensure compatibility, and in an exemplary embodiment the two devices may be purchased as a paired set designed to operate at complementary wavelengths for bidirectional communication over a shared optical path.

This embodiment is particularly advantageous for deployments where rapid installation, scalability, and interoperability with existing network equipment are priorities. Because SFP 1 502 and Rx SFP 2 514 conform to established industry standards, they can be plugged directly into standard network switches, routers, and media converters without custom interface electronics, allowing the free space optical link to appear to the host network as a conventional fiber connection. The SFP devices can be selected and swapped to match the data rate, wavelength, and protocol requirements of a given deployment without redesigning the rest of the terminal, providing a modular upgrade path as network requirements evolve. In an exemplary embodiment, bidirectional SFP devices may be employed at both ends of the link, wherein each SFP handles both transmit and receive functions using slightly different wavelengths for each direction, allowing the system to share common optics and a single reflective liquid crystal spatial light modulator 506 at each terminal for both the outgoing and incoming signals. This further reduces the total component count and terminal footprint. In an exemplary embodiment, reflective liquid crystal spatial light modulator 506 may be replaced by a MEMS mirror, a metasurface, an optical phased array, a digital micromirror device, or any other suitable beam steering technology while preserving the SFP-based architecture described herein, as the modular coupling between the SFP fiber output and the collimator-to-steering-element optical train is independent of the specific steering mechanism employed.

In certain deployment scenarios, a single beam steering technology may not provide both the wide angular coverage required for initial acquisition and the fine angular precision required for sustained high-quality tracking. To address this, an exemplary hybrid steering architecture may combine two or more beam steering elements operating in a coordinated coarse and fine arrangement. A coarse steering element provides wide-angle coverage across a large field of regard to rapidly locate a partner terminal during the acquisition phase, while a fine steering element provides high-precision angular control over a narrower range to maintain optimal alignment during steady-state tracking. The coarse steering element may comprise, by way of example, a MEMS mirror, a gimbal, or a digital micromirror device capable of directing the beam across a broad angular range with moderate precision. The fine steering element may comprise, by way of example, an optical phased array, a liquid crystal spatial light modulator, a metasurface, an acousto-optic modulator, or an electro-optic modulator capable of making rapid, high-resolution angular corrections within a narrower field of regard. During the acquisition sequence, the coarse steering element sweeps the search region to locate the partner terminal and brings the beam within the angular range of the fine steering element. The fine steering element then assumes primary control of the beam direction, applying precise corrections based on feedback from the spatially sensitive detector to achieve and maintain the alignment accuracy necessary for reliable data transmission. During steady-state tracking, the coarse steering element may remain at a fixed position or may apply slow, large-scale corrections to compensate for gradual drift, while the fine steering element handles rapid, small-scale corrections to reject high-frequency disturbances such as vibration and atmospheric turbulence. This division of responsibility allows each steering element to operate within the angular range and response bandwidth for which it is best suited, achieving a combination of wide field of regard and high pointing precision that may not be attainable with either element alone. In an exemplary embodiment, the handoff between coarse and fine steering may be managed by a controller that monitors the angular offset reported by the spatially sensitive detector and transitions primary steering authority from the coarse element to the fine element once the residual offset falls within the fine element's operational range. The hybrid steering architecture may be applied to any of the system embodiments described herein by incorporating a second beam steering element into the optical path of the transmitter, the receiver, or both.

### Description of Method Aspects

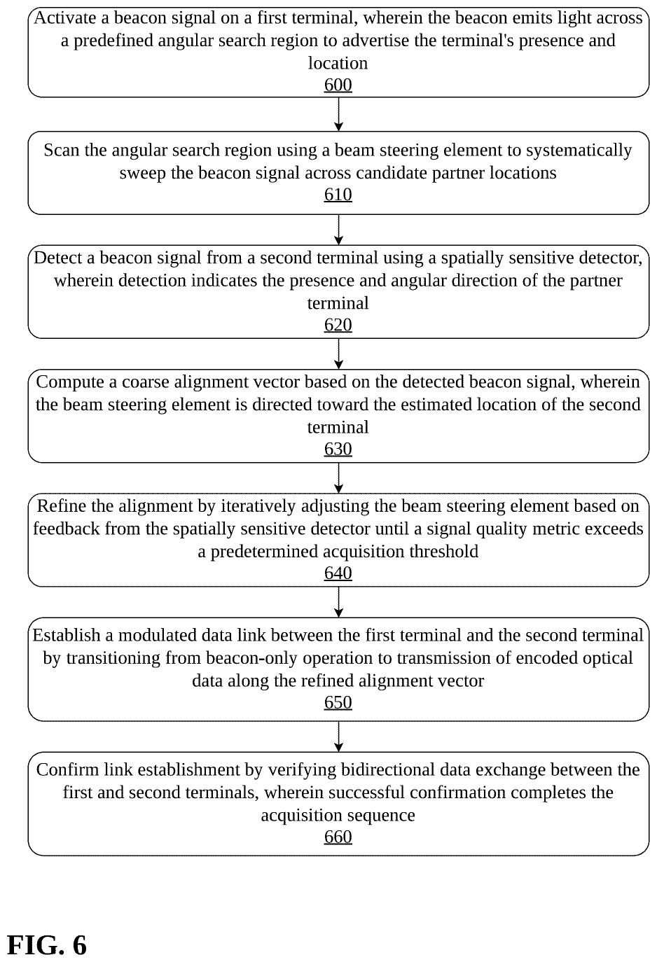

FIG. 6 is a flow diagram illustrating an exemplary method for autonomous acquisition of a free space optical communication link between two terminals. In a first step 600, a beacon signal is activated on a first terminal, wherein the beacon emits light across a predefined angular search region to advertise the terminal's presence and location. The beacon signal is a dedicated optical emission distinct from the communication data channel, configured with sufficient angular coverage and power to be detectable by a partner terminal that has not yet established precise alignment. The angular search region may be defined based on prior knowledge of the deployment geometry or may encompass the full field of regard of the terminal to accommodate unknown partner locations.

In a step 610, the angular search region is scanned using a beam steering element to systematically sweep the beacon signal across candidate partner locations. The scan pattern may follow a raster, spiral, or other predetermined trajectory designed to ensure complete coverage of the search region within an acceptable time window. The scan rate is selected to balance the tradeoff between search speed and the dwell time required at each angular position for reliable detection by the partner terminal.

In a step 620, a beacon signal from a second terminal is detected using a spatially sensitive detector, wherein detection indicates the presence and angular direction of the partner terminal. The spatially sensitive detector produces a measurement that encodes both the intensity and the angular offset of the incoming beacon relative to the detector center, enabling the receiving terminal to determine the direction from which the partner beacon originated. Detection may occur while the first terminal is actively scanning or while it is dwelling at a fixed position within the search region.

In a step 630, a coarse alignment vector is computed based on the detected beacon signal, wherein the beam steering element is directed toward the estimated location of the second terminal. The coarse alignment vector represents an initial angular correction sufficient to bring the transmitted beam into the approximate vicinity of the partner terminal, though not yet precise enough to sustain a high-quality data link. This initial estimate reduces the remaining angular uncertainty from the full search region down to a narrow cone centered on the partner terminal.

In a step 640, the alignment is refined by iteratively adjusting the beam steering element based on feedback from the spatially sensitive detector until a signal quality metric exceeds a predetermined acquisition threshold. Each iteration measures the residual angular offset between the current beam direction and the optimal alignment, applies a corrective adjustment, and re-evaluates the resulting signal quality. The acquisition threshold defines the minimum alignment precision at which the link is considered sufficiently stable to support data transmission.

In a step 650, a modulated data link is established between the first terminal and the second terminal by transitioning from beacon-only operation to transmission of encoded optical data along the refined alignment vector. The transition may occur as an instantaneous switch from beacon to data mode or as a gradual handoff in which the beacon and data signals operate concurrently during an overlap period to ensure alignment is maintained throughout the changeover.

In a step 660, link establishment is confirmed by verifying bidirectional data exchange between the first and second terminals, wherein successful confirmation completes the acquisition sequence. Confirmation may involve exchanging predefined handshake messages, verifying that received data passes error-checking criteria, or validating that signal quality metrics remain above threshold for a sustained verification period. Upon successful confirmation, the link transitions to a steady-state operational mode in which active tracking maintains the established alignment.

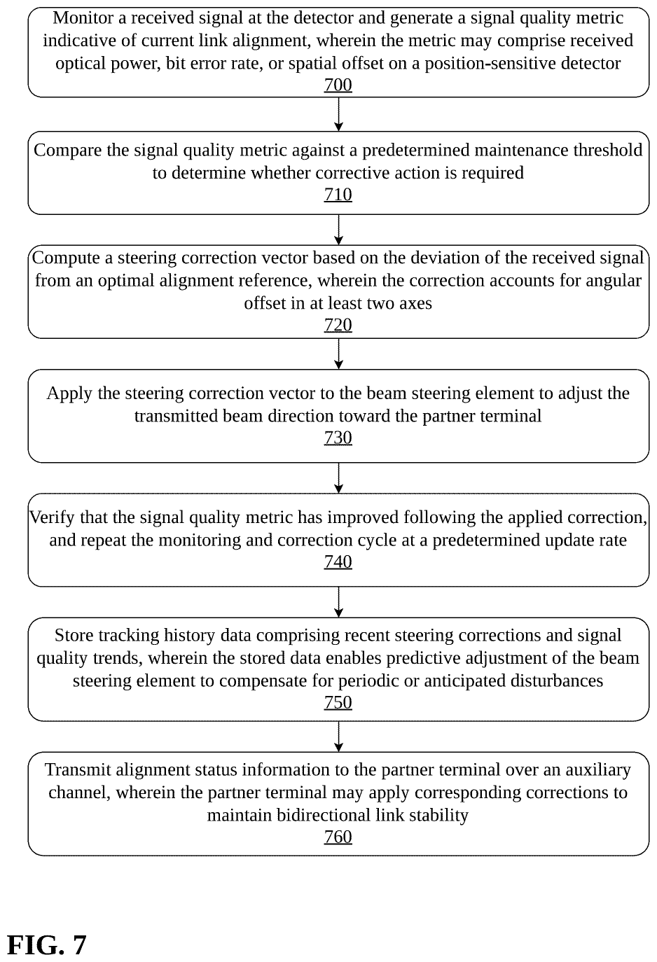

FIG. 7 is a flow diagram illustrating an exemplary method for active tracking and maintenance of an established free space optical communication link between two terminals. In a first step 700, a received signal is monitored and a signal quality metric indicative of current link alignment is generated, wherein the metric may comprise received optical power, bit error rate, or spatial offset on a position-sensitive detector. The signal quality metric provides a continuous, quantitative measure of how well the two terminals are aligned at any given moment. In an exemplary embodiment, the metric may be derived from the differential power distribution across multiple sensing regions of a position-sensitive detector, providing a direct measurement of angular misalignment. In another exemplary embodiment, the metric may be inferred from communication layer statistics such as bit error rate or packet loss rate, which degrade predictably as alignment drifts from optimal. Multiple metrics may be monitored simultaneously and combined into a composite quality indicator to provide a more robust assessment of link health than any single measurement alone.

In a step 710, the signal quality metric is compared against a predetermined maintenance threshold to determine whether corrective action is required. The maintenance threshold defines the boundary between acceptable link performance and a degraded state warranting intervention. The threshold may be set with a margin above the minimum signal level required for reliable data transmission, such that corrective action is initiated while the link still has sufficient quality headroom to sustain uninterrupted communication during the correction process. In an exemplary embodiment, multiple threshold levels may be defined to trigger progressively more aggressive correction strategies as alignment degrades, ranging from fine adjustments for minor drift to broader search patterns for more significant deviations.

In a step 720, a steering correction vector is computed based on the deviation of the received signal from an optimal alignment reference, wherein the correction accounts for angular offset in at least two axes. The correction vector represents the angular adjustment needed to bring the beam back into optimal alignment and is derived from the spatial or intensity characteristics of the received signal. In an exemplary embodiment, the correction vector may be computed using a proportional-integral-derivative control algorithm that accounts for the current offset, accumulated drift over time, and the rate of change of the misalignment to produce a smooth and stable correction response. In another exemplary embodiment, a Kalman filter or similar state estimation technique may be employed to separate true alignment drift from measurement noise, producing more accurate corrections in the presence of atmospheric scintillation or detector noise.

In a step 730, the steering correction vector is applied to the beam steering element to adjust the transmitted beam direction toward the partner terminal. The correction is translated into the appropriate control signals for whatever beam steering technology is employed, and the resulting angular adjustment redirects the transmitted beam to compensate for the detected misalignment. The magnitude and speed of the applied correction may be scaled based on the severity of the detected deviation, with small corrections applied gradually to avoid overcorrection and oscillation, and larger corrections applied more aggressively when the link is at risk of dropping below the minimum operational threshold. In an exemplary embodiment, correction bandwidth may be dynamically adjusted based on the observed disturbance environment, increasing the update rate during periods of high vibration or turbulence and reducing it during stable conditions to conserve processing resources.

In a step 740, the signal quality metric is verified to have improved following the applied correction, and the monitoring and correction cycle is repeated at a predetermined update rate.

This closed-loop verification ensures that each applied correction produces the intended improvement and allows the tracking algorithm to detect and compensate for overcorrection, undercorrection, or changes in the disturbance environment that occurred between the measurement and the correction. The update rate determines how frequently the full monitoring and correction cycle executes, and may range from a few iterations per second for relatively stable deployments to hundreds or thousands of iterations per second for environments subject to rapid vibration or platform motion. In an exemplary embodiment, the update rate may be adaptively adjusted based on observed link stability, increasing when signal quality fluctuations indicate a dynamic disturbance environment and decreasing when the link remains consistently well aligned.

In a step 750, tracking history data comprising recent steering corrections and signal quality trends is stored, wherein the stored data enables predictive adjustment of the beam steering element to compensate for periodic or anticipated disturbances. The accumulated history captures the temporal pattern of alignment corrections over time, revealing periodic disturbances such as building sway, thermal expansion cycles, mechanical vibrations from nearby equipment, or diurnal atmospheric turbulence variations. In an exemplary embodiment, machine learning or artificial intelligence routines may analyze the stored tracking history to build predictive models that anticipate future alignment drift and apply preemptive corrections before the signal quality degrades, reducing the effective tracking latency and improving link stability beyond what purely reactive correction can achieve. In another exemplary embodiment, reinforcement learning techniques may be employed to continuously optimize the correction strategy based on observed outcomes, adapting to changes in the disturbance environment over time without requiring manual recalibration.

In a step 760, alignment status information is transmitted to the partner terminal over an auxiliary channel, wherein the partner terminal may apply corresponding corrections to maintain bidirectional link stability. Sharing alignment status between terminals enables coordinated tracking in which both ends of the link contribute to maintaining optimal alignment rather than relying on a single terminal to bear the full correction burden. The auxiliary channel may be, by way of example, a low-bandwidth radio frequency link or an in-band optical sideband that operates alongside the primary communication data without consuming significant link capacity. In an exemplary embodiment, the exchanged status information may include the current steering correction state, the measured signal quality at each terminal, and any predictive adjustment parameters derived from stored tracking history, enabling both terminals to synchronize their correction strategies and avoid conflicting adjustments that could degrade rather than improve overall link performance.

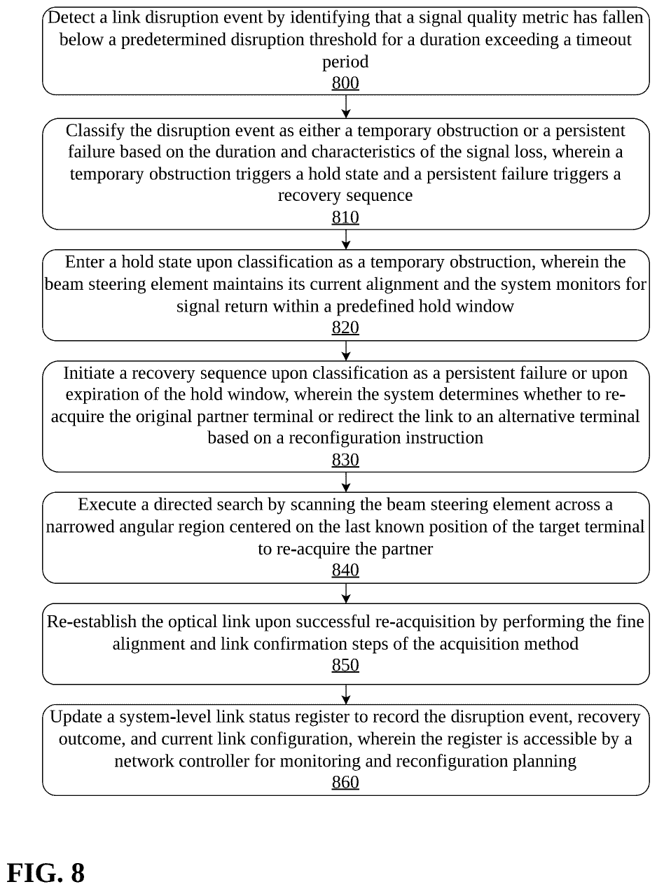

FIG. 8 is a flow diagram illustrating an exemplary method for self-healing and reconfiguration of a free space optical communication link following a disruption event. In a first step 800, a link disruption event is detected by identifying that a signal quality metric has fallen below a predetermined disruption threshold for a duration exceeding a timeout period. The disruption threshold is set below the maintenance threshold used during normal active tracking, representing a level of signal degradation beyond what the tracking correction loop can compensate for. The timeout period prevents momentary signal fluctuations caused by transient atmospheric effects or brief vibration events from being mischaracterized as true disruptions, ensuring that the self-healing process is initiated only when the link has experienced a sustained loss of usable signal.

In a step 810, the disruption event is classified as either a temporary obstruction or a persistent failure based on the duration and characteristics of the signal loss, wherein a temporary obstruction triggers a hold state and a persistent failure triggers a recovery sequence. Classification may consider factors such as the rate at which the signal degraded, whether any residual signal remains at a reduced level, and whether the pattern of loss is consistent with known obstruction profiles such as a person or object passing through the beam path. In an exemplary embodiment, a rapid and complete loss of signal followed by partial signal return within a short interval may be classified as a temporary obstruction, while a gradual degradation that stabilizes below the disruption threshold may indicate a persistent mechanical drift or environmental change requiring active recovery.

In a step 820, a hold state is entered upon classification as a temporary obstruction, wherein the beam steering element maintains its current alignment and monitoring continues for signal return within a predefined hold window. The hold state preserves the last known good alignment so that when the obstruction clears, the link can resume immediately without requiring a full reacquisition sequence. The hold window defines the maximum duration for which the current alignment will be maintained before the disruption is reclassified as a persistent failure. In an exemplary embodiment, the hold window duration may be configurable based on the deployment environment, with shorter windows for time-critical links where rapid recovery is essential and longer windows for environments where temporary obstructions are frequent and expected to resolve on their own.

In a step 830, a recovery sequence is initiated upon classification as a persistent failure or upon expiration of the hold window, wherein a determination is made whether to re-acquire the original partner terminal or redirect the link to an alternative terminal based on a reconfiguration instruction. This decision point enables the self-healing process to serve both recovery and reconfiguration functions depending on operational needs. In the absence of a reconfiguration instruction, the default behavior is to attempt re-acquisition of the original partner at its last known position. When a reconfiguration instruction is present, the recovery sequence targets the designated alternative terminal instead, enabling dynamic rerouting of communication paths in response to changing network requirements or the permanent loss of a partner terminal. In an exemplary embodiment, the reconfiguration instruction may originate from a centralized network controller that maintains awareness of the overall link topology and issues redirect commands based on current traffic demands, redundancy requirements, or fault isolation procedures.

In a step 840, a directed search is executed by scanning the beam steering element across a narrowed angular region centered on the last known position of the target terminal to re-acquire the partner. The directed search covers a reduced angular region compared to the full acquisition search, exploiting the prior knowledge of where the target terminal was last successfully tracked to accelerate the recovery process. The search region may be sized based on the expected range of displacement since the link was lost, accounting for factors such as the elapsed time during the hold state and the maximum expected drift rate of the target terminal. In an exemplary embodiment, the directed search may progressively expand the angular search region if the initial narrowed search does not locate the target within a predetermined number of scan cycles, eventually widening to a full acquisition search if the target has moved significantly from its last known position.

In a step 850, the optical link is re-established upon successful re-acquisition by performing fine alignment and link confirmation. Once the directed search locates the target terminal, the alignment is refined through iterative correction until the signal quality exceeds the acquisition threshold, and bidirectional data exchange is verified to confirm that the link is fully operational. The fine alignment and confirmation process follows the same procedural sequence as the initial acquisition, ensuring that the re-established link meets the same quality standards as a newly formed connection.

In a step 860, a link status register is updated to record the disruption event, recovery outcome, and current link configuration, wherein the register is accessible by a network controller for monitoring and reconfiguration planning. The recorded information may include the time and duration of the disruption, the classification assigned to the event, whether recovery was successful and how many search cycles were required, and the identity of the terminal to which the link is now connected. This historical record enables trend analysis over time, allowing patterns of recurring disruptions to be identified and addressed through preventive measures such as repositioning terminals, adjusting beam paths to avoid known obstruction zones, or provisioning redundant links across routes that have demonstrated higher failure rates. In an exemplary embodiment, the link status register may be maintained locally at each terminal and periodically synchronized with a centralized network controller, providing both local autonomy for immediate recovery decisions and global visibility for network-wide planning and optimization.

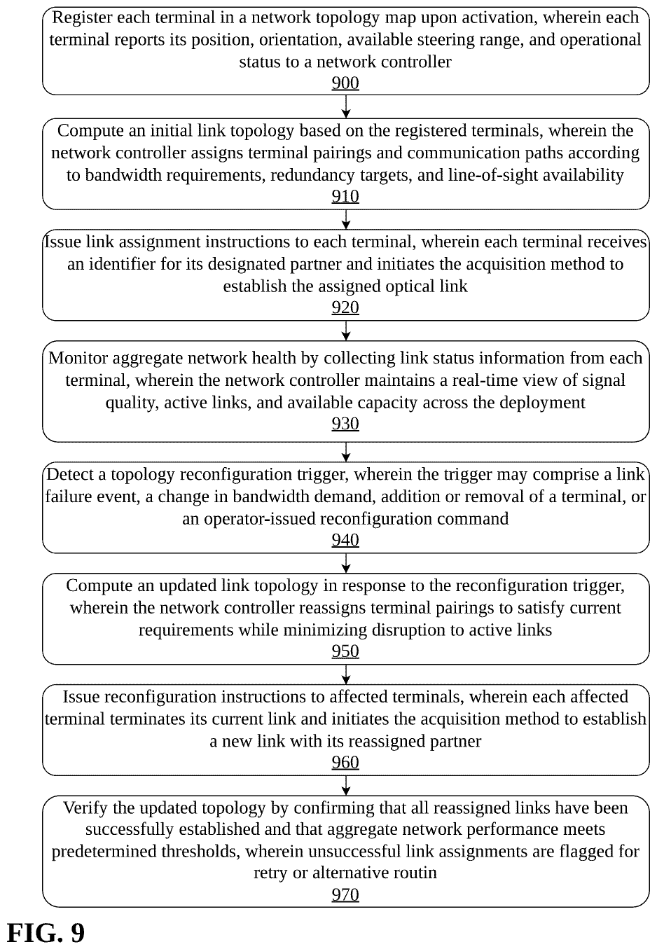

FIG. 9 is a flow diagram illustrating an exemplary method for network-level orchestration and topology management of a plurality of free space optical terminals within a deployment environment. In a first step 900, each terminal is registered in a network topology map upon activation, wherein each terminal reports its position, orientation, available steering range, and operational status to a network controller. Registration establishes the network controller's awareness of each available terminal and its capabilities, creating a comprehensive inventory from which link assignments can be computed. The reported information defines the physical and operational constraints of each terminal, including which angular regions it can address and which partner terminals fall within its reachable field of regard. In an exemplary embodiment, registration may occur automatically upon terminal power-on, with each terminal broadcasting its parameters over a low-bandwidth auxiliary channel or a wired management interface to the network controller without requiring manual configuration or cable installation.

In a step 910, an initial link topology is computed based on the registered terminals, wherein the network controller assigns terminal pairings and communication paths according to bandwidth requirements, redundancy targets, and line-of-sight availability. The topology computation determines which terminals should be connected to one another to satisfy the current communication demands of the deployment. The network controller evaluates the available line-of-sight paths between all registered terminals and selects pairings that collectively meet aggregate bandwidth requirements while respecting redundancy targets that ensure continued network operation in the event of individual link failures. In an exemplary embodiment, the topology computation may incorporate latency optimization by favoring direct line-of-sight pairings that minimize the physical propagation distance between communicating endpoints, taking advantage of the fact that optical signals traveling through free space follow the shortest geometric path and propagate faster in air than in glass fiber.

In a step 920, link assignment instructions are issued to each terminal, wherein each terminal receives an identifier for its designated partner and initiates the acquisition method to establish the assigned optical link. The assignment instruction provides each terminal with sufficient information to locate and acquire its designated partner, which may include the partner's registered position, angular bearing relative to the receiving terminal, and any wavelength or protocol parameters needed to establish a compatible connection. Upon receiving the assignment, each terminal autonomously executes its acquisition sequence to find, align with, and confirm a data link to the designated partner without further intervention from the network controller. In an exemplary embodiment, link assignments may be issued simultaneously to all terminals or sequenced in a prioritized order that establishes the highest-priority connections first, reducing contention during the acquisition phase in dense deployments where multiple terminals may be scanning overlapping angular regions concurrently.

In a step 930, aggregate network health is monitored by collecting link status information from each terminal, wherein the network controller maintains a real-time view of signal quality, active links, and available capacity across the deployment. Each terminal periodically reports its current link performance metrics, active connection status, and any anomalies detected by its tracking or self-healing processes. The network controller aggregates these reports into a unified view that represents the overall health and utilization of the optical network. In an exemplary embodiment, the monitoring interval may be adapted based on network stability, with more frequent status collection during periods of active reconfiguration or environmental disturbance and less frequent collection during stable steady-state operation to minimize management overhead.

In a step 940, a topology reconfiguration trigger is detected, wherein the trigger may comprise a link failure event, a change in bandwidth demand, addition or removal of a terminal, or an operator-issued reconfiguration command. The network controller continuously evaluates incoming status information and external inputs against conditions that warrant a change to the current link topology. A link failure event reported by an individual terminal's self-healing process that cannot be resolved locally may escalate to the network level as a reconfiguration trigger. Changes in bandwidth demand may arise from shifting traffic patterns, new applications coming online, or scheduled capacity adjustments. In an exemplary embodiment, the addition of a newly activated terminal that registers with the network controller may automatically trigger a topology recomputation to incorporate the new terminal into the network and take advantage of the additional connectivity it provides.

In a step 950, an updated link topology is computed in response to the reconfiguration trigger, wherein the network controller reassigns terminal pairings to satisfy current requirements while minimizing disruption to active links. The recomputation balances the need to address the triggering condition against the cost of disrupting links that are currently operating satisfactorily. Links that are unaffected by the reconfiguration trigger are preferentially preserved, and only the minimum number of link changes necessary to resolve the triggering condition are introduced. In an exemplary embodiment, the topology computation may evaluate multiple candidate topologies and select the option that achieves the required connectivity changes while affecting the fewest active links and requiring the shortest total reconfiguration time, accounting for the expected acquisition duration of each new link assignment based on the angular separation and range between the reassigned terminal pairs.

In a step 960, reconfiguration instructions are issued to affected terminals, wherein each affected terminal terminates its current link and initiates the acquisition method to establish a new link with its reassigned partner. Only terminals whose link assignments have changed receive reconfiguration instructions, while all other terminals continue operating on their existing links without interruption. Each affected terminal gracefully terminates its current connection, updates its target partner information, and begins the acquisition sequence for its new assignment. In an exemplary embodiment, the network controller may coordinate the timing of reconfiguration instructions so that both terminals in a reassigned pair receive their instructions simultaneously, ensuring that the newly designated partners begin searching for each other at the same time and minimizing the acquisition duration.

In a step 970, the updated topology is verified by confirming that all reassigned links have been successfully established and that aggregate network performance meets predetermined thresholds, wherein unsuccessful link assignments are flagged for retry or alternative routing. The network controller checks that each reconfigured terminal has completed its acquisition sequence and confirmed bidirectional data exchange with its new partner. Any link assignment that fails to establish within an expected time window is identified and subjected to further action, which may include retrying the same assignment, computing an alternative pairing that avoids the problematic path, or provisioning a temporary backup route through intermediate terminals to maintain connectivity while the issue is investigated. In an exemplary embodiment, the verification process may include an end-to-end performance validation that measures aggregate throughput, latency, and redundancy coverage across the reconfigured network to confirm that the updated topology meets or exceeds the operational requirements that motivated the reconfiguration.

### Hardware Architecture

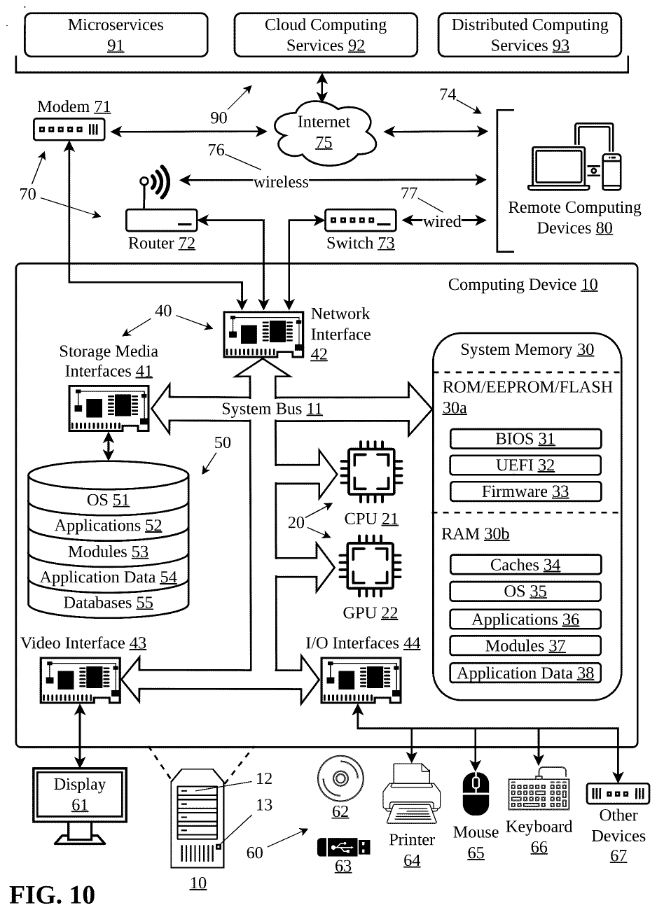

FIG. 10 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI) 32, which is a modern replacement for BIOS that supports larger hard drives, faster boot times, more security features, and provides native support for graphics and mouse cursors. Non-volatile memory 30a may also be used to store firmware 33 comprising a complete operating system 35 and applications 36 for operating computer-controlled devices. The firmware approach is often used for purpose-specific computer-controlled devices such as appliances and Internet-of-Things (IOT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories 34 which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ 45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

1. An optical communication system comprising:
a first terminal comprising a light source configured to generate a modulated optical signal encoding a data stream, a beam steering element configured to direct the modulated optical signal through free space toward a second terminal, and a controller configured to command the beam steering element;
a second terminal comprising collection optics configured to receive the modulated optical signal from the first terminal, a detector configured to convert the received modulated optical signal into an electrical data stream, and a spatially sensitive detector configured to generate alignment information indicative of an angular offset between the modulated optical signal and the second terminal;
a pointing, acquisition, and tracking system configured to perform an acquisition sequence in which the beam steering element scans an angular search region to locate the second terminal and iteratively refines alignment based on the alignment information generated by the spatially sensitive detector until a signal quality metric exceeds a predetermined acquisition threshold; and
a feedback system configured to continuously monitor the signal quality metric during an established communication link and to compute and apply steering corrections to the beam steering element to maintain alignment between the first terminal and the second terminal in the presence of environmental disturbances;
wherein the beam steering element comprises at least one of a microelectromechanical systems mirror, an optical phased array, a liquid crystal spatial light modulator, a metasurface, a digital micromirror device, an acousto-optic modulator, an electro-optic modulator, a Risley prism, or a liquid lens.

2. The optical communication system of claim 1, wherein the first terminal further comprises a beacon light source configured to emit a beacon signal at a wavelength distinct from the modulated optical signal, and the second terminal further comprises a beacon filter configured to pass light at the beacon wavelength while rejecting light at the wavelength of the modulated optical signal, wherein the pointing, acquisition, and tracking system performs the acquisition sequence based on the beacon signal independently of the modulated optical signal.

3. The optical communication system of claim 1, wherein the first terminal further comprises a Small Form-factor Pluggable transceiver device configured to generate the modulated optical signal and output the modulated optical signal through a fiber optic port, and a collimator configured to receive the modulated optical signal from the fiber optic port and produce a collimated beam directed onto the beam steering element.

4. The optical communication system of claim 1, further comprising a network controller in communication with a plurality of terminals including the first terminal and the second terminal, wherein the network controller is configured to:
compute a link topology assigning terminal pairings based on bandwidth requirements, redundancy targets, and line-of-sight availability;
issue link assignment instructions directing each terminal to initiate the acquisition sequence with a designated partner terminal; and
issue reconfiguration instructions to reassign terminal pairings in response to a reconfiguration trigger comprising at least one of a link failure event, a change in bandwidth demand, an addition or removal of a terminal, or an operator-issued reconfiguration command.

5. The optical communication system of claim 1, wherein the feedback system is further configured to:
detect a link disruption event when the signal quality metric falls below a predetermined disruption threshold for a duration exceeding a timeout period;
classify the link disruption event as either a temporary obstruction or a persistent failure;
enter a hold state maintaining a current alignment of the beam steering element upon classification as a temporary obstruction; and
initiate a recovery sequence comprising a directed search across a narrowed angular region centered on a last known position of the second terminal upon classification as a persistent failure or upon expiration of the hold state.

6. The optical communication system of claim 2, wherein the beacon light source is further configured to modulate the beacon signal to encode control data for communication to the second terminal, and wherein the second terminal further comprises a beacon detector configured to receive the beacon signal and to extract the control data from the beacon signal, wherein the control data and the alignment information are communicated between the first terminal and the second terminal without requiring a radio frequency link or a wired data connection between the first terminal and the second terminal.

7. A method for establishing and maintaining a free space optical communication link between a first terminal and a second terminal, the method comprising the steps of:
activating a beacon signal on a first terminal, wherein the beacon signal emits light across an angular search region;
scanning the angular search region using a beam steering element on the first terminal to sweep the beacon signal across candidate locations of a second terminal;
detecting a beacon signal from the second terminal using a spatially sensitive detector on the first terminal, wherein detection of the beacon signal indicates an angular direction of the second terminal;
computing a coarse alignment vector based on the detected beacon signal and directing the beam steering element toward an estimated location of the second terminal;
refining alignment by iteratively adjusting the beam steering element based on feedback from the spatially sensitive detector until a signal quality metric exceeds a predetermined acquisition threshold;
establishing a modulated data link between the first terminal and the second terminal by transmitting encoded optical data along a refined alignment vector;
monitoring the signal quality metric during the established modulated data link and computing a steering correction vector when the signal quality metric falls below a predetermined maintenance threshold; and
applying the steering correction vector to the beam steering element to adjust a direction of the modulated data link toward the second terminal to maintain alignment in the presence of environmental disturbances.

8. The method of claim 7, further comprising the steps of:
detecting a link disruption event by identifying that the signal quality metric has fallen below a predetermined disruption threshold for a duration exceeding a timeout period;
classifying the link disruption event as either a temporary obstruction or a persistent failure based on a duration and characteristics of a signal loss;
entering a hold state upon classification as a temporary obstruction, wherein the beam steering element maintains a current alignment and monitors for signal return within a predefined hold window; and
initiating a recovery sequence upon classification as a persistent failure or upon expiration of the hold window, wherein the recovery sequence comprises executing a directed search by scanning the beam steering element across a narrowed angular region centered on a last known position of the second terminal.

9. The method of claim 7, further comprising the steps of:
storing tracking history data comprising recent steering corrections and signal quality trends; and
computing a predictive adjustment to the beam steering element based on the stored tracking history data to compensate for periodic or anticipated disturbances prior to a degradation of the signal quality metric below the predetermined maintenance threshold.

10. The method of claim 7, further comprising the steps of:
transmitting alignment status information from the first terminal to the second terminal over an auxiliary channel, wherein the auxiliary channel comprises at least one of a radio frequency link or an in-band optical sideband; and
receiving corresponding alignment status information from the second terminal, wherein steering corrections applied at the first terminal and corresponding corrections applied at the second terminal are coordinated based on the exchanged alignment status information to maintain bidirectional link stability.

11. The method of claim 7, further comprising the steps of:
registering the first terminal and the second terminal in a network topology map maintained by a network controller, wherein each terminal reports a position, an orientation, an available steering range, and an operational status;
receiving a link assignment instruction from the network controller designating the second terminal as a partner for the first terminal;
reporting link status information to the network controller during the established modulated data link; and
receiving a reconfiguration instruction from the network controller directing the first terminal to terminate the established modulated data link and initiate the acquisition sequence with a third terminal designated as a reassigned partner.

12. The method of claim 7, further comprising the steps of:
modulating the beacon signal on the first terminal to encode control data for communication to the second terminal;
receiving the beacon signal at the second terminal and extracting the control data from the beacon signal; and
coordinating operation between the first terminal and the second terminal based on the extracted control data without requiring a radio frequency link or a wired data connection between the first terminal and the second terminal.
